(19) United States
(12) Patent Application Publication
(10) Pub. No.: US 2024/0404550 A1
(43) Pub. Date: Dec. 5, 2024

(54) NON-TRANSITORY COMPUTER READABLE MEDIUM, AND CONVERSATION EVALUATION APPARATUS AND METHOD

(71) Applicant: KABUSHIKI KAISHA TOSHIBA, Tokyo (JP)

(72) Inventor: Daichi HAYAKAWA, Inzai Chiba (JP)

(73) Assignee: KABUSHIKI KAISHA TOSHIBA, Tokyo (JP)

(21) Appl. No.: 18/584,926

(22) Filed: Feb. 22, 2024

(30) Foreign Application Priority Data
Jun. 1, 2023 (JP) 2023-091036

(51) Int. Cl. G10L 25/87; G10L 25/93

(52) U.S. Cl. CPC G10L 25/87; G10L 25/93

(57) ABSTRACT

According to one embodiment, a non-transitory computer readable medium includes computer executable instructions. The instructions, when executed by a processor, cause the processor to perform a method. The method estimates a starting time and an ending time of an utterance of each main speaker relating to a conversation. The method identifies a timing of a switch between the main speakers. The method evaluates a state of the conversation based on dialogue information before and after the identified timing of the switch. The dialogue information includes at least one of a length of an overlapping segment or a length of a silent segment, and includes a length of an utterance segment.

### CROSS-REFERENCE TO RELATED APPLICATIONS

This application is based upon and claims the benefit of priority from Japanese Patent Application No. 2023-091036, filed Jun. 1, 2023, the entire contents of which are incorporated herein by reference.

### FIELD

Embodiments described herein relate generally to a non-transitory computer readable medium, and a conversation evaluation apparatus and method.

### BACKGROUND

In general, companies need to improve each employee's engagement with the company in order to improve labor productivity. Thus, companies need to evaluate the state (especially the health) of communication among employees.

For example, there is a technology of evaluating, in a conversation between a first speaker and a second speaker, the state of the communication between the two speakers using a length of an overlapping segment in which the two speakers' utterance segments overlap. This technology regards, as an overlapping segment, a period from the time point at which the second speaker starts speaking while the first speaker is speaking to the time point at which the first speaker ends his/her utterance, and evaluates the second speaker's impression in relation to the first speaker as “normal” or “bad” according to the length of this overlapping segment.

The above technology, however, cannot objectively evaluate the first speaker's impression independently from the second speaker's position since it evaluates the first speaker's impression with respect to the second speaker. For example, the first speaker's impression may be unfairly evaluated as “bad” even though the second speaker, who cuts in while the first speaker is speaking, is actually bad. Therefore, appropriate evaluation of the state of the communication among multiple speakers is required.

### BRIEF DESCRIPTION OF THE DRAWINGS

FIG. 1 is a block diagram showing an example of a function configuration of a conversation evaluation apparatus according to an embodiment.

FIG. 2 is a block diagram showing an example of a hardware configuration of the conversation evaluation apparatus according to an embodiment.

FIG. 3 is a flowchart showing an example of an entire operation of the conversation evaluation apparatus according to an embodiment.

FIG. 4 is a flowchart showing a method of estimating a main speaker's utterance according to an embodiment.

FIG. 5 is a diagram showing an example of a conversation analysis according to an embodiment.

FIG. 6 is a flowchart showing a method of evaluating a state of a conversation according to an embodiment.

FIG. 7 is a diagram showing an example of dialogue information according to an embodiment.

FIG. 8 is a diagram showing an example of displaying an evaluation result according to an embodiment.

FIG. 9 is a diagram showing examples of the estimation accuracy of conversation analyses according to a conventional method and a proposed method.

### DETAILED DESCRIPTION

In general, according to one embodiment, a non-transitory computer readable medium includes computer executable instructions. The instructions, when executed by a processor, cause the processor to perform a method. The method estimates a starting time and an ending time of an utterance of each main speaker based on voice data relating to a conversation that includes utterances of multiple speakers. The method identifies a timing of a switch between the main speakers based on the estimated starting time and the estimated ending time. The method evaluates a state of the conversation based on dialogue information before and after the identified timing of the switch. The dialogue information includes at least one of a length of an overlapping segment in which utterance segments of the main speakers overlap or a length of a silent segment in which utterance segments of the main speakers do not overlap, and includes a length of the utterance segment of each of the main speakers.

Hereinafter, a non-transitory computer readable medium, and a conversation evaluation apparatus and method according to embodiments will be described with reference to the accompanying drawings. In the embodiments described below, elements assigned with the same reference symbols perform the same operations, and repeat descriptions will be omitted as appropriate.

A definition of each term according to the embodiments will be given herein. (1) The term “utterance” refers to an utterance segment (voice segment) between two silent segments of 0.2 seconds or more. (2) The term “main speaker” refers to a speaker in a conversation. (3) The term “non-main speaker” refers to a listener of a main speaker. The content of an utterance of a non-main speaker often includes back-channel feedback to a main speaker's utterance or a fragmentary repetition of a main speaker's utterance. (4) The term “switch between main speakers” refers to a switch between two main speakers. (5) The term “main speaker's turn” refers to a collection of utterances made by the main speaker in a period from the time when the main speaker takes his/her turn to the time when the turn is switched from the main speaker to the next main speaker. (6) The term “length of a main speaker's utterance segment” refers to a total length of all utterance segments in one turn that a main speaker takes.

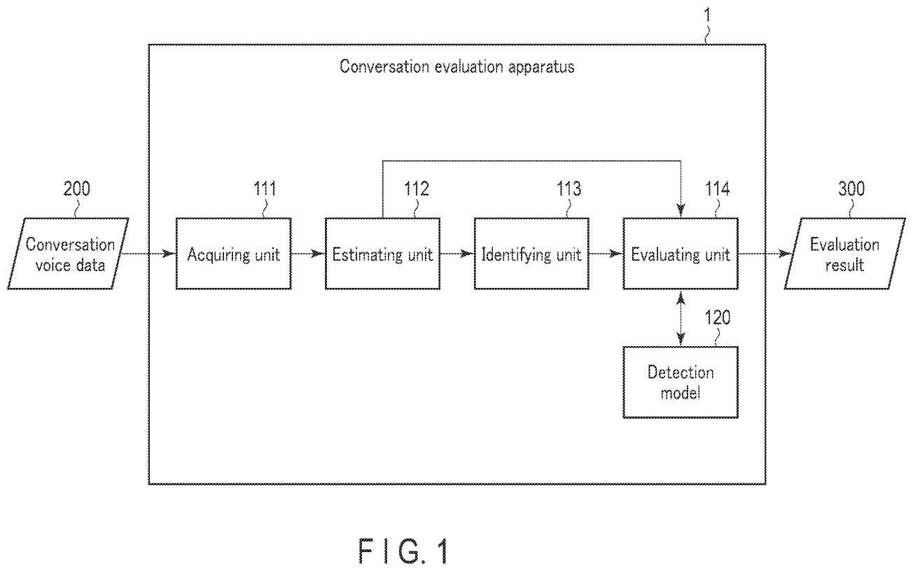

FIG. 1 is a block diagram showing an example of a function configuration of a conversation evaluation apparatus 1 according to an embodiment. The conversation evaluation apparatus 1 is an apparatus that evaluates the state of a conversation among multiple speakers. The conversation evaluation apparatus 1 includes an acquiring unit 111, an estimating unit 112, an identifying unit 113, and an evaluating unit 114.

The acquiring unit 111 acquires various kinds of data or information. For example, the acquiring unit 111 acquires conversation voice data 200 relating to a conversation including each utterance of multiple speakers. The conversation voice data 200 is data in which changes in an electric signal relating to a conversation voice are recorded in time series. The acquiring unit 111 transmits the acquired conversation voice data 200 to the estimating unit 112.

The estimating unit 112 estimates various kinds of data or information. For example, the estimating unit 112 estimates a starting time and an ending time of an utterance made by each main speaker based on the conversation voice data 200 transmitted from the acquiring unit 111. The estimating unit 112 transmits the estimated starting time and ending time to the identifying unit 113 and the evaluating unit 114.

The identifying unit 113 identifies various kinds of data or information. For example, the identifying unit 113 identifies the timing of the switch between the main speakers (hereinafter referred to as “switch between speakers”) based on the starting time and the ending time transmitted from the estimating unit 112. The identifying unit 113 transmits the identified switching timing to the evaluating unit 114.

The evaluating unit 114 evaluates various kinds of data or information. For example, the evaluating unit 114 evaluates a state of a conversation relating to the switching timing transmitted from the identifying unit 113 based on dialogue information D before and after the switching timing. The dialogue information D includes at least one of a length of an overlapping segment in which the main speakers' utterance segments overlap or a length of a silent segment in which the main speakers' utterance segments do not overlap, and includes a length of each main speaker's utterance segment. The dialogue information D may include the starting time and the ending time transmitted from the estimating unit 112. The evaluating unit 114 inputs the dialogue information D to a detection model 120 trained in advance and thereby acquires an evaluation result 300 relating to the state of the conversation from the detection model 120. The evaluating unit 114 outputs the acquired evaluation result 300.

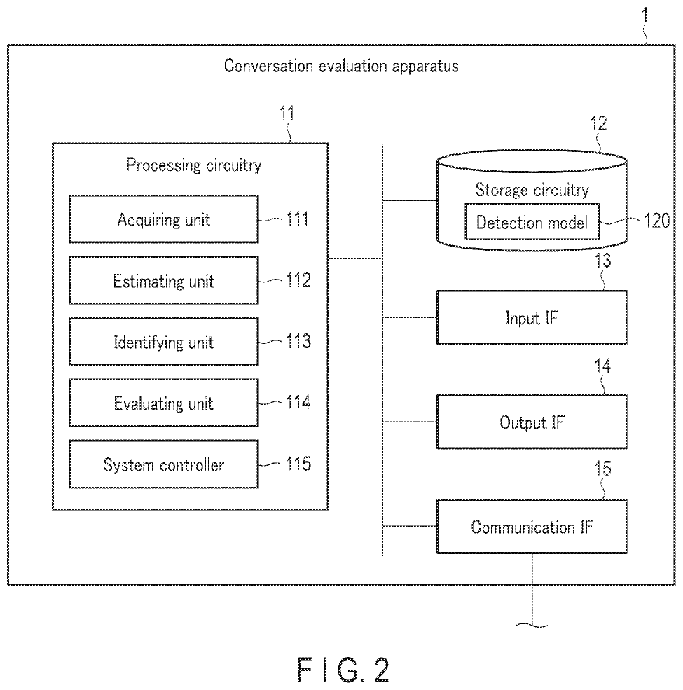

FIG. 2 is a block diagram showing an example of a hardware configuration of the conversation evaluation apparatus 1 according to an embodiment. For example, the conversation evaluation apparatus 1 is a computer (e.g., a personal computer, a tablet terminal, a smartphone). The conversation evaluation apparatus 1 includes processing circuitry 11, storage circuitry 12, an input IF 13, an output IF 14, and a communication IF 15 as its components. These components are connected to one another via a bus (BUS), which is a common signal communication path, in such a manner as to be able to communicate with one another.

The processing circuitry 11 is circuitry that controls the entire operation of the conversation evaluation apparatus 1. The processing circuitry 11 includes at least one processor. The processor refers to circuitry such as a CPU (central processing unit), a GPU (graphics processing unit), an ASIC (application specific integrated circuit), or a programmable logic device (for example, an SPLD (simple programmable logic device), a CPLD (complex programmable logic device), or an FPGA (field programmable gate array)). If the processor is a CPU, the CPU implements each function by reading and executing the programs stored in the storage circuitry 12. If the processor is an ASIC, each function is directly incorporated into the ASIC as logic circuitry. The processor may be constituted in the form of single circuitry or in the form of multiple independent sets of circuitry combined. The processing circuitry 11 implements the acquiring unit 111, the estimating unit 112, the identifying unit 113, the evaluating unit 114, and a system controller 115. The processing circuitry 11 is an example of a processor.

The system controller 115 controls various operations performed by the processing circuitry 11. For example, the system controller 115 provides an operating system (OS) for the processing circuitry 11 to implement each unit (the acquiring unit 111, the estimating unit 112, the identifying unit 113, and the evaluating unit 114).

The storage circuitry 12 is circuitry that stores various kinds of data or information. The storage circuitry 12 may be a processor-readable storage medium (e.g., a magnetic storage medium, an electromagnetic storage medium, an optical storage medium, a semiconductor memory) or a drive that reads and writes data or information to and from a storage medium. The storage circuitry 12 stores programs that cause the processing circuitry 11 to implement each unit (the acquiring unit 111, the estimating unit 112, the identifying unit 113, the evaluating unit 114, and the system controller 115). The storage circuitry 12 may store the detection model 120. The storage circuitry 12 is an example of a storage.

The input IF 13 is an interface that receives various inputs from a user. The input IF 13 converts the received inputs into electric signals and transmits the electric signals to the processing circuitry 11. The input IF 13 may be a mouse, a keyboard, a button, a panel switch, a slider switch, a trackball, an operation panel, or a touch screen. The input IF 13 may be installed outside the conversation evaluation apparatus 1. The input IF 13 is an example of an input unit.

The output IF 14 is an interface that outputs various kinds of data or information to a user. The output IF 14 outputs various kinds of data or information according to the electric signals transmitted from the processing circuitry 11. The output IF 14 may be a display device (e.g., a monitor) or an acoustic device (e.g., a speaker). The output IF 14 may be installed outside the conversation evaluation apparatus 1. The output IF 14 is an example of an output unit, a display unit, or an acoustic unit.

The communication IF 15 is an interface that communicates various kinds of data or information with external devices. The communication IF 15 is an example of a communication unit.

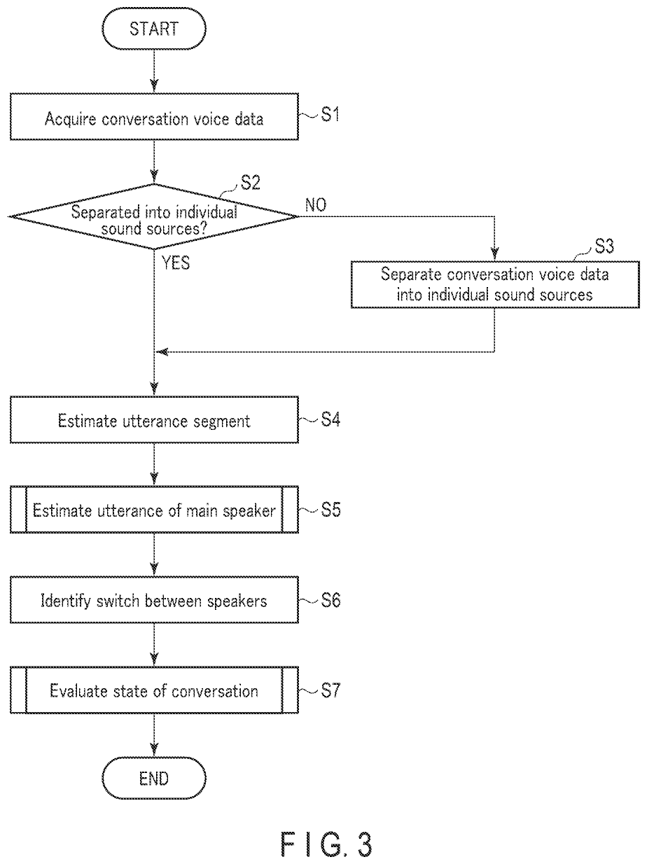

FIG. 3 is a flowchart showing an example of an entire operation of the conversation evaluation apparatus 1 according to an embodiment. According to this operation example, the conversation evaluation apparatus 1 outputs the evaluation result 300 by analyzing the conversation voice data 200. In particular, the conversation evaluation apparatus 1 may start this example operation according to an instruction input by a user through the input IF 13. The conversation evaluation apparatus 1 may acquire the conversation voice data 200 from the communication IF 15 and present the evaluation result 300 to the user through the output IF 14.

(Step S1) First, the conversation evaluation apparatus 1 acquires the conversation voice data 200 by using the acquiring unit 111. The conversation voice data 200 is acquired by at least one sound pickup device. For example, the conversation voice data 200 is voice data relating to a telephone conference, a web conference, or a video conference that multiple speakers conduct using their own sound pickup devices. The sound pickup device may be a receiver or a built-in microphone installed in a smartphone or a personal computer of each speaker. Alternatively, the sound pickup device may be a headset microphone or a desktop microphone connected to the personal computer of each speaker.

(Step S2) Next, by using the acquiring unit 111, the conversation evaluation apparatus 1 determines whether or not the conversation voice data 200 acquired in step S1 is separated into individual sound sources. Specifically, the acquiring unit 111 determines whether or not the conversation voice data 200 is separated into the voices of respective speakers (separated voices). If the conversation voice data 200 is separated into individual sound sources (step S2-YES), the process proceeds to step S4. If the conversation voice data 200 is not separated into individual sound sources (step S2-NO), the process proceeds to step S3.

Firstly, let us assume the case where the conversation voice data 200 is collected from the respective sound pickup devices of multiple speakers. In this case, the conversation voice data 200 includes the voices of the respective speakers individually since each sound pickup device collects voice data from a single speaker. Thus, the conversation evaluation apparatus 1 determines that the conversation voice data 200 is separated into individual sound sources.

Secondly, let us assume the case where the conversation voice data 200 is collected from a single sound pickup device. In this case, the conversation voice data 200 includes a mixture of respective speakers' voices (mixed voices) since the sound pickup device collects the voices of the speakers simultaneously. Thus, the conversation evaluation apparatus 1 determines that the conversation voice data 200 is not separated into individual sound sources.

(Step S3) Subsequently, by using the acquiring unit 111, the conversation evaluation apparatus 1 separates, into individual sound sources, the conversation voice data 200 determined not to be separated into individual sound sources in step S2. Thus, the conversation voice data 200 includes the voices of the respective speakers individually. The audio source separation can be realized by a publicly known technique (see Non-Patent Literature 1: Nobutaka Ito, Christopher Schymura, Shoko Araki and Tomohiro Nakatani, “Noisy cGMM: Complex Gaussian Mixture Model with Non-Sparse Noise Model for Joint Source Separation and Denoising”, 2018 26th European Signal Processing Conference (EUSIPCO), Rome, Italy, 2018, pp. 1662-1666).

(Step S4) Subsequently, by using the estimating unit 112, the conversation evaluation apparatus 1 estimates the utterance segments of the respective speakers based on the voices of the respective speakers included individually in the conversation voice data 200. Specifically, the estimating unit 112 estimates the starting time and the ending time of the utterance made by each speaker and the length of the utterance segment. The length of the utterance segment is a duration from the starting time to the ending time of the utterance. The estimation of the utterance segment can be realized by a publicly known technique (see Non-Patent Literature 2: Jongseo Sohn, Nam Soo Kim and Wonyong Sung, “A statistical model-based voice activity detection”, IEEE Signal Processing Letters, 1999, Vol. 6, No. 1, pp. 1-3).

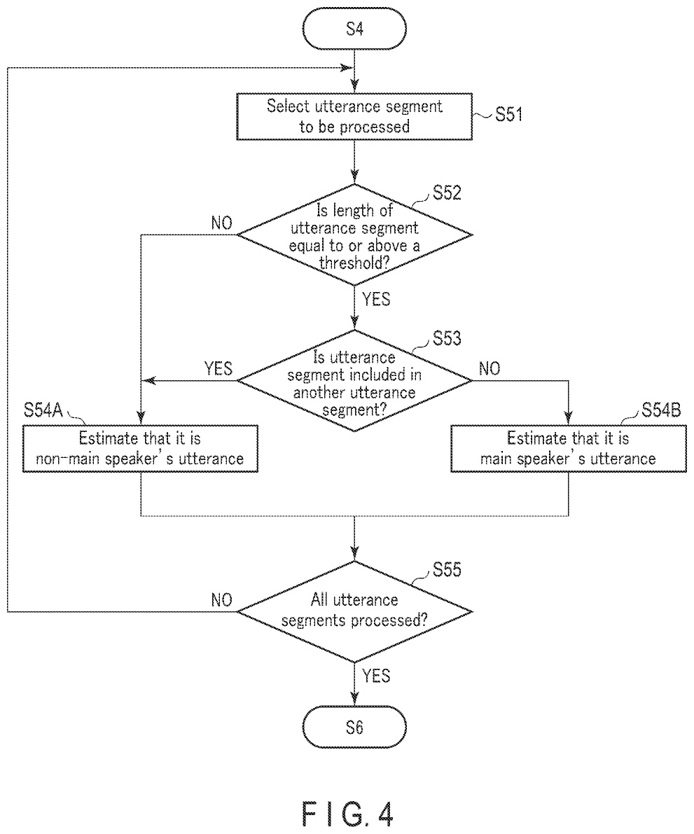

(Step S5) Subsequently, by using the estimating unit 112, the conversation evaluation apparatus 1 estimates the utterance of each main speaker based on the utterance segment of each speaker estimated in step S4 (see FIG. 4).

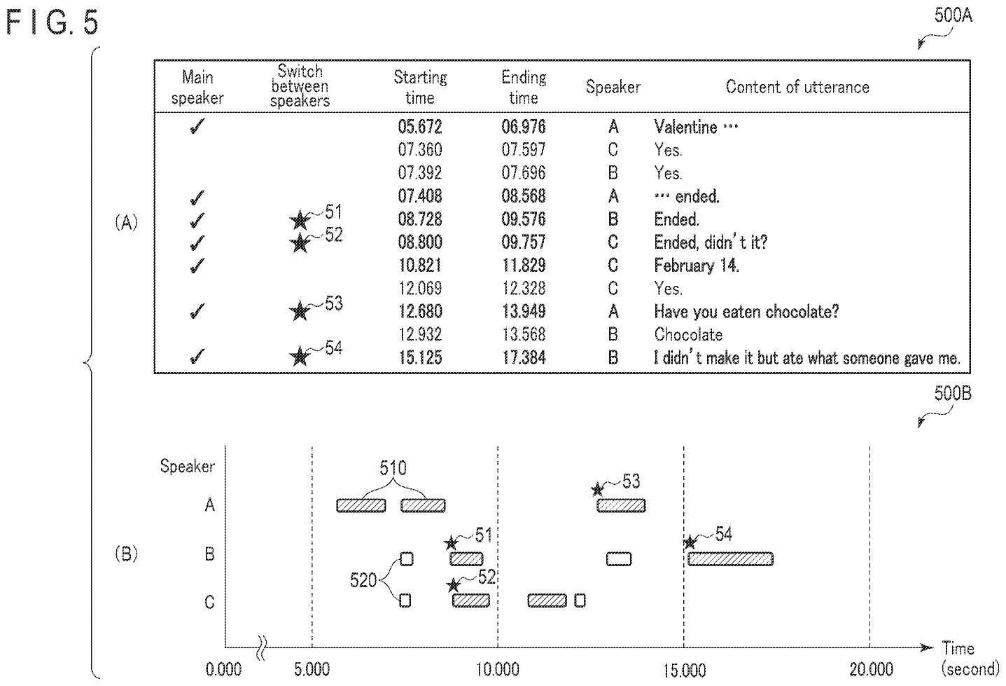

(Step S6) Subsequently, by using the identifying unit 113, the conversation evaluation apparatus 1 identifies the switch between the main speakers based on the utterances of the main speakers estimated in step S5. Specifically, the identifying unit 113 determines whether or not two main speakers are different from each other in terms of the temporally adjacent two utterance segments of the main speakers. If the two main speakers are different from each other, the identifying unit 113 identifies that the main speakers are switched between the two utterance segments of the main speakers (see FIG. 5).

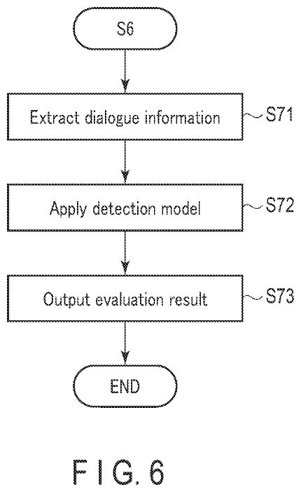

(Step S7) Lastly, for the switch between the speakers identified in step S6, the conversation evaluation apparatus 1 outputs, by using the evaluating unit 114, the evaluation result 300 relating to the state of the conversation in the conversation voice data 200 based on the dialogue information D obtained before and after the speakers are switched (see FIG. 6). After step S7, the conversation evaluation apparatus 1 ends the series of operations.

FIG. 4 is a flowchart showing a method of estimating a main speaker's utterance according to an embodiment. According to this estimation method, the estimating unit 112 estimates, for each of the utterance segments to be processed, whether the utterance is a main speaker's utterance or a non-main speaker's utterance.

(Step S51) First, the estimating unit 112 selects an utterance segment to be processed from among all the utterance segments estimated in step S4. For example, the estimating unit 112 selects an utterance segment of an utterance having the earliest starting time from among all the unprocessed utterance segments. That is, one utterance segment to be processed is selected every time step S51 is performed.

(Step S52) Next, the estimating unit 112 determines, for the utterance segment selected in step S51, whether or not the length of the utterance segment is equal to or above a threshold. This threshold is empirically determined (e.g., 0.5 seconds). If the length of the utterance segment is equal to or above a threshold (step S52-YES), the process proceeds to step S53. If the length of the utterance segment is not equal to or above a threshold (step S52-NO), the process proceeds to step S54A. That is, the estimating unit 112 estimates that an utterance segment not having a length equal to or above a threshold is a short utterance such as back-channel feedback and is a non-main speaker's utterance.

(Step S53) Subsequently, the estimating unit 112 determines, for the utterance segment determined to have a length equal to or above a threshold in step S52, whether or not the utterance segment is included in another utterance segment. Specifically, the estimating unit 112 determines whether or not a starting time and an ending time of the utterance segment are included in a period from a starting time to an ending time of another utterance segment. If the utterance segment is included in another utterance segment (step S53-YES), the process proceeds to step S54A. If the utterance segment is not included in another utterance segment (step S53-NO), the process proceeds to step S54B.

(Step S54A) In this case, the estimating unit 112 estimates that the utterance segment selected in step S51 is an utterance of a “non-main speaker”. After step S54A, the process proceeds to step S55.

(Step S54B) In this case, the estimating unit 112 estimates that the utterance segment selected in step S51 is an utterance of a “main speaker”. After step S54B, the process proceeds to step S55.

(Step S55) Subsequently, the estimating unit 112 determines whether or not all the utterance segments estimated in step S4 are processed in the process from step S51 to step S54A or S54B. If all the utterance segments are processed (step S55-YES), the process proceeds to step S6 (see FIG. 3). If not all the utterance segments are processed (step S55-NO), the process returns to step S51.

The method of estimating the main speaker's utterance is not limited to the above method. The estimating unit 112 may use an external voice recognition system to recognize the content of each utterance. If the recognized utterance content includes only back-channel feedback, the estimating unit 112 estimates that the utterance is an utterance of a “non-main speaker”. In contrast, the estimating unit 112 estimates that an utterance not estimated to be a non-main speaker's utterance is an utterance of a “main speaker”.

FIG. 5 is a diagram showing an example of a conversation analysis according to an embodiment. The table 500A in FIG. 5(A) shows the result of the analysis of the conversation in the conversation voice data 200. The graph 500B in FIG. 5(B) graphically shows the result of the analysis of the conversation described in the table 500A. The table 500A or the graph 500B may be displayed on the output IF 14 that serves as a display device.

The table 500A shows a conversation among three speakers (A, B, and C). The table 500A shows the utterances from the respective speakers in a row direction, and shows each item relating to the utterances in a column direction. The items are “main speaker” in the first column, “switch between speakers” in the second column, “starting time” in the third column, “ending time” in the fourth column, “speaker” in the fifth column, and “content of utterance” in the sixth column.

The “main speaker” in the first column indicates, using check marks, the main speaker's utterance estimated in step S5 shown in FIG. 3 (see FIG. 4). Specifically, among the eleven utterances included in the table 500A, seven utterances, the first, the fourth to the seventh, the ninth, and the eleventh utterances from the top, are estimated to be the utterances of the “main speakers”. In contrast, four utterances, the second to the third, the eighth, and the tenth utterances from the top, are estimated to be the utterances of the “non-main speakers”. That is, the utterances including back-channel feedback (“Yes”) or a fragmentary repetition (“Chocolate”) as the content of the utterances are estimated to be the utterances of the “non-main speakers”.

The “switch between speakers” in the second column indicates, using star marks 51, 52, 53, and 54, the switch between the main speakers identified in step S6 shown in FIG. 3. Specifically, among the eleven utterances included in the table 500A, the star marks 51, 52, 53, and 54 are attached to four utterances, the fifth, the sixth, the ninth, and the eleventh utterances from the top. The star marks 51, 52, 53, and 54 are attached to the utterances after the speakers are switched.

The graph 500B shows three speakers (A, B, and C) in the vertical direction, and shows the utterance segments of the respective speakers in the horizontal direction. Among the utterance segments, the utterance of the “main speaker” is indicated by a bar 510 with slashes, and the utterance of the “non-main speaker” is indicated by a white bar 520. Each of the bars 510 and 520 corresponds to the eleven utterances included in the table 500A. The four bars 510 with the star marks 51, 52, 53, and 54 in the graph 500B correspond to the four utterances with the star marks 51, 52, 53, and 54 in the table 500A.

FIG. 6 is a flowchart showing a method of evaluating a state of a conversation according to an embodiment. According to the evaluation method, the evaluating unit 114 outputs the evaluation result 300 based on the dialogue information D obtained before and after the speakers are switched.

(Step S71) First, for each of the switches between speakers identified in step S6, the evaluating unit 114 extracts the dialogue information D before and after the speakers are switched.

For example, let us focus on the first switch between speakers with the star mark 51 in FIG. 5. As can be understood from the table 500A and the graph 500B, this switch between speakers is a switch from the main speaker A to the main speaker B. The length of the utterance segment in the main speaker A's turn before the speakers are switched is the lengths of the utterance segments of two utterances, the first and the fourth utterances from the top in the table 500A. This length is computed as (6.976−5.672)+(8.568−7.408)=2.464 (second). On the other hand, the length of the utterance segment in the main speaker B's turn after the speakers are switched is the length of the utterance segment of the fifth utterance from the top in the table 500A. This length is computed as (9.576−8.728)=0.848 (second).

In addition, in the first switch between speakers

with the star mark 51, the main speaker A's utterance segment and the main speaker B's utterance segment do not overlap each other. Specifically, according to the ending time “8.568” of the fourth utterance segment from the top in the table 500A and the starting time “8.728” of the fifth utterance segment from the top in the table 500A, the two utterance segments do not overlap each other. Thus, there is “no” overlapping segment, and the length of the overlapping segment is “0.000” (second). In contrast, there is a silent segment between the two utterance segments. Thus, there “exists” a silent segment, and the length of the silent segment is computed as (8.728−8.568)=0.160 (second).

Next, let us focus on the second switch between speakers with the star mark 52 in FIG. 5. As can be understood from the table 500A and the graph 500B, this switch between speakers is a switch from the main speaker B to the main speaker C. The length of the utterance segment in the main speaker B's turn before the speakers are switched is the length of the utterance segment of the fifth utterance from the top in the table 500A. This length is computed as (9.576−8.728)=0.848 (second). On the other hand, the length of the utterance segment in the main speaker C's turn after the speakers are switched is the lengths of the utterance segments of two utterances, the sixth and the seventh utterances from the top in the table 500A. This length is computed as (9.757−8.800)+(11.829−10.821)=1.965 (second).

In addition, in the second switch between speakers with the star mark 52, the main speaker B's utterance segment and the main speaker C's utterance segment overlap each other. Specifically, according to the ending time “9.576” of the fifth utterance segment from the top in the table 500A and the starting time “8.800” of the sixth utterance segment from the top in the table 500A, the two utterance segments overlap each other. Thus, there “exists” an overlapping segment, and the length of the overlapping segment is (9.576−8.800)=0.776 (second). In contrast, there is no silent segment between the two utterance segments. Thus, there is “no” silent segment, and the length of the silent segment is “0.000” (second).

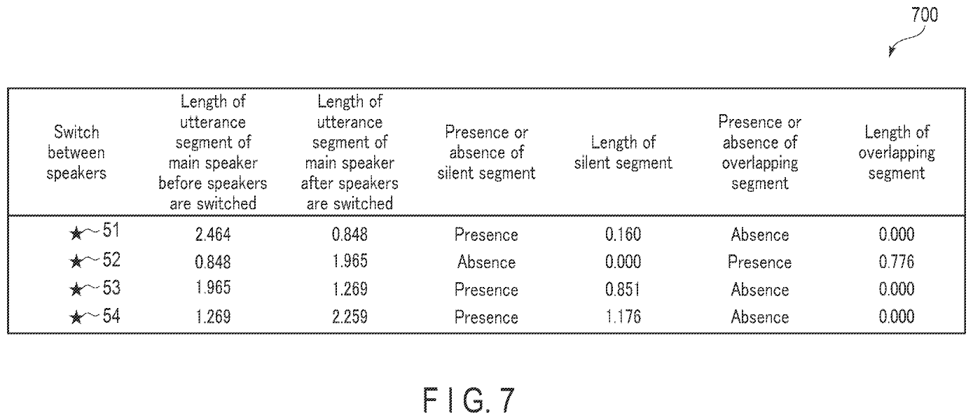

Likewise, the evaluating unit 114 extracts the dialogue information D for each of the switches between speakers with the star marks 53 and 54 (see FIG. 7).

(Step S72) Next, the evaluating unit 114 applies the trained detection model 120 to the dialogue information D of the respective switches between speakers extracted in step S71. Specifically, the evaluating unit 114 detects a predetermined event or probability for each switch between speakers as the evaluation result 300 by inputting the dialogue information D of each switch between speakers to the trained detection model 120.

The detection model 120 is trained using training data that adopts the dialogue information D of the switch between speakers as input data and adopts a label indicating the state of the conversation before and after the speakers are switched as correct data. For example, the detection model 120 is trained using training data that adopts the dialogue information D as input data and adopts, as correct data, a probability with which a predetermined event occurs if this dialogue information D is given.

Firstly, the detection model 120 is trained using paired data consisting of the dialogue information D and a label indicating whether or not the speakers are switched coercively. In this case, the trained detection model 120 can detect the “probability with which the speakers are switched coercively”. Secondly, the detection model 120 is trained using paired data consisting of the dialogue information D and a label indicating the name of the main speaker who is speaking coercively. In this case, the trained detection model 120 can detect the “probability with which the respective main speakers are speaking coercively”. Thirdly, the detection model 120 is trained using paired data consisting of the dialogue information D and a label indicating a value relating to whether a conversation is active or not. In this case, the trained detection model 120 can detect the “degree of activity of a conversation”.

For example, let us focus on the four switches between speakers with the star marks 51, 52, 53, and 54 in FIG. 5. Herein, the dialogue information D of the N-th switch between speakers is assumed to be Xₙ, and a probability with which a predetermined event occurs at the N-th switch between speakers is assumed to be Yₙ (n: a natural number of 1 to N). It is also assumed that the dialogue information D includes (1) a length of an utterance segment of a main speaker before the speakers are switched, (2) a length of an utterance segment of a main speaker after the speakers are switched, (3) a length of a silent segment, and (4) a length of an overlapping segment. In this case, the dialogue information X₁ of the first switch between speakers is represented by X₁={2.464, 0.848, 0.160, 0.000}. Likewise, the dialogue information X₂, X₃, and X₄ of the second, the third, and the fourth switches between speakers are represented by X₂={0.848, 1.965, 0.000, 0.776}, X₃={1.965, 1.269, 0.851, 0.000}, and X₄={1.269, 2.259, 1.176, 0.000}, respectively.

The evaluating unit 114 inputs the dialogue information X₁ to the trained detection model 120, whereby the trained detection model 120 outputs a probability Y₁ with which a predetermined event occurs at the first switch between speakers. Likewise, the evaluating unit 114 inputs the dialogue information X₂, X₃, and X₄ to the trained detection model 120, whereby the trained detection model 120 outputs probabilities Y₂, Y₃, and Y₄ with which predetermined events occur at the second, the third, and the fourth switches between speakers.

The detection model 120 may be a machine-trained

model (e.g., a regression model, a support vector machine, a decision tree, a neural network). The detection model 120 may output a probability Yₙ of an occurrence of a predetermined event for each piece of dialogue information Xₙ or output a probability of an occurrence of a predetermined event for each of consecutive pieces of dialogue information.

In addition, the input data input to the detection model 120 may include a feature amount other than the dialogue information D. Specifically, the input data may include an acoustic feature amount (e.g., average, variance) relating to a pitch or power of a main speaker's voice before and after the speakers are switched. Alternatively, the input data may include text information indicating the content of the utterance of each main speaker acquired through voice recognition.

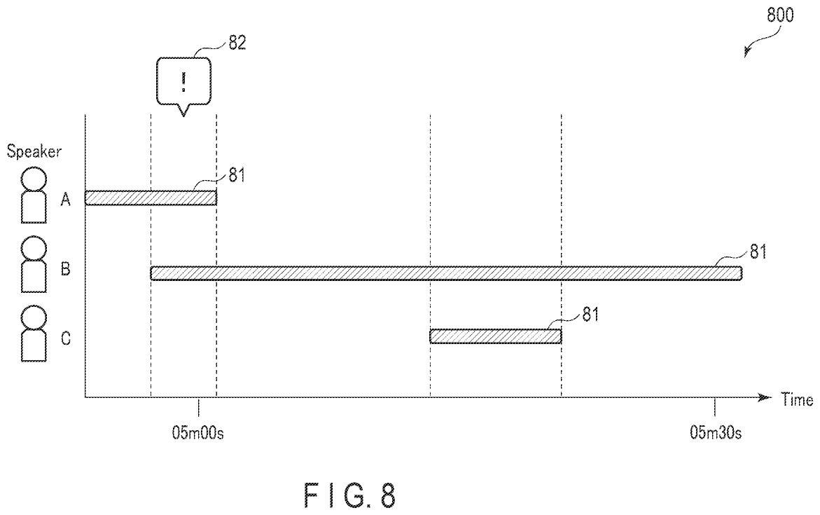

(Step S73) Lastly, the evaluating unit 114 generates the evaluation result 300 based on the predetermined event (probability Yₙ) detected for each piece of dialogue information Xₙ (switch between speakers) in step S72. For example, if the probability Yₙ is equal to or above a threshold, the evaluating unit 114 generates alert information in association with the dialogue information Xₙ. The evaluating unit 114 outputs the evaluation result 300 by integrating the alert information generated for each piece of dialogue information Xₙ, etc. For example, the evaluation result 300 is displayed on the output IF 14 that serves as a display device (see FIG. 8).

FIG. 7 is a diagram showing an example of the dialogue information D according to an embodiment. The table 700 in FIG. 7 shows the dialogue information D extracted for each of the four switches between speakers in the table 500A and the graph 500B shown in FIG. 5.

The table 700 shows the switches between speakers with the star marks 51, 52, 53, and 54, respectively, in a row direction, and shows items relating to the respective switches between speakers in a column direction. The items are “a switch between the speakers” in the first column, “a length of an utterance segment of a main speaker before the speakers are switched” in the second column, “a length of an utterance segment of a main speaker after the speakers are switched” in the third column, “the presence or absence of a silent segment” in the fourth column, “a length of a silent segment” in the fifth column, “the presence or absence of an overlapping segment” in the sixth column, and “a length of an overlapping segment” in the seventh column.

FIG. 8 is a diagram showing an example of displaying the evaluation result 300 according to an embodiment. The conversation evaluation apparatus 1 may output the evaluation result 300 ex-post facto by performing the operations shown in FIG. 3 when voice recording of the conversation is completed after a telephone conference, a web conference, or a video conference (i.e., off-line operation). Alternatively, the conversation evaluation apparatus 1 may output the evaluation result 300 in real time by performing the operations shown in FIG. 3 while obtaining the conversation voice data 200 in real time during a telephone conference, a web conference, or a video conference (i.e., real-time operation).

(Example of Off-line Operation) Let us assume, for example, the case where three speakers (A, B, and C) hold a meeting in a conference room. Let us also assume that the speaker B starts speaking in such a manner as to interrupt the speaker A's utterance during the meeting and continues speaking unilaterally for a long time. After the meeting ends, the conversation evaluation apparatus 1 performs the operations shown in FIG. 3 based on the conversation voice data 200 collected by a sound pickup device installed in the conference room.

The graph 800 shows the three speakers (A, B, and C) in the vertical direction, and shows the utterance segments of the respective speakers in the horizontal direction. Each utterance segment is shown by a bar 81 with slashes. In particular, the speakers are switched from the speaker A to the speaker B around the time “05m00s”. If a coercive switch between the speakers is detected based on the dialogue information D obtained before and after the speakers are switched, alert information is displayed in association with the switch between the speakers. For example, the alert information is represented by the box 82.

(Example 1 of Real-time Operation) Likewise, let us assume the case where three speakers (A, B, and C) hold a meeting in a conference room. The conversation evaluation apparatus 1 performs the operations shown in FIG. 3 based on the conversation voice data 200 collected in real time by a sound pickup device installed in the conference room. If a coercive switch between the speakers is detected a number of times equal to or above a threshold during the meeting, the conversation evaluation apparatus 1 outputs alert information indicating that “there is a possibility that the speakers were switched coercively during the meeting”. For example, the conversation evaluation apparatus 1 transmits electronic mail including this alert information to a terminal of a supervisor who manages the three speakers (A, B, and C) or to a terminal of a human resources department.

(Example 2 of Real-time Operation) Let us assume, for example, the case where three speakers (A, B, and C) hold an online meeting under the presence of one facilitator F. The conversation evaluation apparatus 1 performs the operations shown in FIG. 3 based on the conversation voice data 200 collected in real time during the meeting. The conversation evaluation apparatus 1 transmits, in real time, the evaluation result 300 indicating the degree of activity of the meeting to a terminal of the facilitator F. Also, if the degree of activity of the meeting is equal to or below a threshold for a predetermined time period or a predetermined number of times, the conversation evaluation apparatus 1 outputs alert information indicating that “the meeting is inactive”. For example, the conversation evaluation apparatus 1 transmits electronic mail including this alert information to the terminal of the facilitator F.

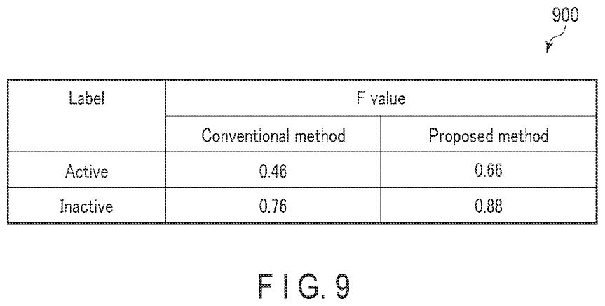

FIG. 9 is a diagram showing examples of the estimation accuracy of conversation analyses according to a conventional method and a proposed method. The table 900 shows the accuracy of the estimation of the degree of activity of a conversation of three people obtained using two detection models 120 trained by different training methods. XGboost (extreme Gradient Boosting), a type of decision tree, was used for the detection models 120.

To make a comparison between the conventional method and the proposed method, voice data of 10 sessions of small talk by three speakers was prepared as a data set. This voice data included 6280 switches between the main speakers in total, and a label indicating “active” or “inactive” was attached manually to each switch between the main speakers.

In the conventional method, (1) a length of an overlapping segment was attached as the dialogue information D to each of the above switches between the main speakers. In the proposed method, (1) a length of an overlapping segment, (2) a length of a silent segment, (3) a length of an utterance segment of a main speaker before the speakers are switched, and (4) a length of an utterance segment of a main speaker after the speakers are switched were attached as the dialogue information D to each of the above switches between the main speakers. As a result, paired data including the dialogue information D and the label was created for each of the 6280 switches between the main speakers.

Next, 80% of all the sets of paired data were used as training data, and the remaining 20% of sets of paired data were used as evaluation data. The detection model 120 was trained using this training data. The trained detection model 120 estimated the labels corresponding to the respective pieces of dialogue information D included in the evaluation data to be “active” or “inactive”. The accuracy of the estimation of the labels performed by the trained detection model 120 was computed by comparing the estimated labels and a correct label. An F value (F-measure) was used as a measure for evaluating the accuracy of the estimation of the labels. The closer the F value is to “1.0”, the higher the accuracy of the estimation of the labels.

According to the table 900, the F value of the label “active” estimated by the detection model 120 trained by the conventional method is “0.46”, and the F value of the label “inactive” estimated by the detection model 120 trained by the conventional method is “0.76”. On the other hand, the F value of the label “active” estimated by the detection model 120 trained by the proposed method is “0.66”, and the F value of the label “inactive” estimated by the detection model 120 trained by the proposed method is “0.88”. That is, it is understood that the detection model 120 trained by the proposed method shows a higher accuracy of the estimation of the labels “active” and “inactive”, as compared to the detection model 120 trained by the conventional method.

According to the embodiments described above, the conversation evaluation apparatus 1 can appropriately evaluate the state of a communication among multiple speakers. In particular, the conversation evaluation apparatus 1 can objectively evaluate the state of a conversation among multiple speakers.

Firstly, if two utterance segments overlap each other when the main speakers are switched, the conversation evaluation apparatus 1 uses the length of the utterance segment of the first speaker before the occurrence of the overlap and the length of the utterance segment of the second speaker after the occurrence of the overlap. Thus, the conversation evaluation apparatus 1 can evaluate which of the two speakers, the first speaker or the second speaker, is speaking unilaterally. In other words, the conversation evaluation apparatus 1 can evaluate which of the two speakers, the first speaker or the second speaker, is speaking coercively.

Secondly, the conversation evaluation apparatus 1 can evaluate the degree of activity of a conversation between two speakers by using the lengths of the utterance segments of the two speakers and the length of the silent segment at the time of a switch between the two speakers. For example, if the silent segment is short and the lengths of the utterance segments of the two speakers are long, the conversation evaluation apparatus 1 can evaluate that the conversation between the two speakers is active. In contrast, if the silent segment is long and the lengths of the utterance segments of the two speakers are short, the conversation evaluation apparatus 1 can evaluate that the conversation between the two speakers is inactive.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A non-transitory computer readable medium including computer executable instructions, wherein the instructions, when executed by a processor, cause the processor to perform a method comprising:
estimating a starting time and an ending time of an utterance of each main speaker based on voice data relating to a conversation that includes utterances of multiple speakers;
identifying a timing of a switch between the main speakers based on the estimated starting time and the estimated ending time; and
evaluating a state of the conversation based on dialogue information before and after the identified timing of the switch,
wherein the dialogue information includes at least one of a length of an overlapping segment in which utterance segments of the main speakers overlap or a length of a silent segment in which utterance segments of the main speakers do not overlap, and includes a length of the utterance segment of each of the main speakers.

2. The medium according to claim 1, wherein the estimating estimates, as the utterances of the main speakers, an utterance which has an utterance segment having a length equal to or above a threshold and whose utterance segment is not included in another utterance segment.

3. The medium according to claim 1, wherein the evaluating evaluates the state of the conversation by using a trained model, the trained model being a model trained using training data that adopts the dialogue information as input data and adopts, as correct data, a label indicating a state of the conversation before and after the timing of the switch.

4. The medium according to claim 3, wherein
the label is a name of a main speaker who speaks coercively, and
the evaluating outputs a probability with which the main speakers speak coercively as an evaluation result relating to the state of the conversation.

5. The medium according to claim 3, wherein
the label is a value relating to whether the conversation is active or not, and
the evaluating outputs a degree of activity of the conversation as an evaluation result relating to the state of the conversation.

6. The medium according to claim 1, wherein if a coercive switch between the main speakers is detected based on the dialogue information, the evaluating outputs alert information in association with the timing of the switch at which the coercive switch between the main speakers is detected.

7. The medium according to claim 1, wherein if a coercive switch between the main speakers is detected in the conversation a number of times equal to or above a threshold based on the dialogue information, the evaluating outputs alert information.

8. The medium according to claim 1, wherein if the conversation is detected as being inactive a number of times equal to or above a threshold based on the dialogue information, the evaluating outputs alert information.

9. A conversation evaluation apparatus comprising processing circuitry configured to:
estimate a starting time and an ending time of an utterance of each main speaker based on voice data relating to a conversation that includes utterances of multiple speakers;
identify a timing of a switch between the main speakers based on the estimated starting time and the estimated ending time; and
evaluate a state of the conversation based on dialogue information before and after the identified timing of the switch,
wherein the dialogue information includes at least one of a length of an overlapping segment in which utterance segments of the main speakers overlap or a length of a silent segment in which utterance segments of the main speakers do not overlap, and includes a length of the utterance segment of each of the main speakers.

10. A conversation evaluation method comprising:
estimating a starting time and an ending time of an utterance of each main speaker based on voice data relating to a conversation that includes utterances of multiple speakers;
identifying a timing of a switch between the main speakers based on the estimated starting time and the estimated ending time; and
evaluating a state of the conversation based on dialogue information before and after the identified timing of the switch,
wherein the dialogue information includes at least one of a length of an overlapping segment in which utterance segments of the main speakers overlap or a length of a silent segment in which utterance segments of the main speakers do not overlap, and includes a length of the utterance segment of each of the main speakers.
